(19) United States
(12) Patent Application Publication
(10) Pub. No.: US 2018/0096682 A1
(43) Pub. Date: Apr. 5, 2018

(54) IMAGE PROCESSING APPARATUS, AUDIO PROCESSING METHOD THEREOF AND RECORDING MEDIUM FOR THE SAME

(71) Applicant: SAMSUNG ELECTRONICS CO., LTD., Suwon-si (KR)

(72) Inventors: Dae-woo CHO, Yongin-si (KR); Tae-hoon KIM, Suwon-si (KR); Myoung-jun LEE, Suwon-si (KR); Min-sup KIM, Suwon-si (KR)

(73) Assignee: SAMSUNG ELECTRONICS CO., LTD., Suwon-si (KR)

(21) Appl. No.: 15/718,674

(22) Filed: Sep. 28, 2017

(30) Foreign Application Priority Data
Sep. 30, 2016 (KR) 10-2016-0126065

(51) Int. Cl. G10L 15/22; G10L 25/51; G10L 25/84; G10L 15/26; G10L 21/0232

(52) U.S. Cl. CPC G10L 15/22; G10L 25/51; G10L 2015/223; G10L 15/26; G10L 21/0232; G10L 25/84

(57) ABSTRACT

An image processing apparatus includes a loudspeaker configured to output a sound based on a first audio signal, a receiver configured to receive a second audio signal from a microphone, and at least one processor configured to execute a first voice recognition with regard to the first audio signal and the second audio signal respectively, execute a second voice recognition with regard to the second audio signal in response to results from applying the first voice recognition to the first audio signal and the second audio signal being different from each other, and skip the second voice recognition with regard to the second audio signal in response to the results from applying the first voice recognition to the first audio signal and the second audio signal being equal to each other.

### CROSS-REFERENCE TO RELATED THE APPLICATION

This application claims priority from Korean Patent Application No. 10-2016-0126065 filed on Sep. 30, 2016 in the Korean Intellectual Property Office, the disclosure of which is incorporated herein by reference.

### BACKGROUND

### Field

Apparatuses and methods consistent with the exemplary embodiments relate to an image processing apparatus and a recording medium, in which content such as a video signal, an application, etc. received from various providers is processed to be displayed as an image, and more particularly to an image processing apparatus and a recording medium, in which a voice recognition function for recognizing a user's speech is supported and a malfunction of recognizing speech even when there is no user's speech is prevented.

### Description of the Related Art

To compute and process predetermined information in accordance with certain processes, an electronic apparatus basically includes a central processing unit (CPU), a chipset, a memory, and the like electronic components for computation. Such an electronic apparatus may be classified variously in accordance with what information will be processed therein. For example, the electronic apparatus is classified into an information processing apparatus such as a personal computer, a server or the like for processing general information, and an image processing apparatus for processing image information.

The image processing apparatus processes a video signal or video data received from the exterior in accordance with various video processing processes. The image processing apparatus may display an image based on the processed video data on its own display, or output the processed video data to a separate external apparatus provided with a display so that the corresponding external apparatus can display an image based on the processed video signal. As an example of the image processing apparatus that has no display, there is a set-top box. On the other hand, the image processing apparatus that has its own display is called a display apparatus, and may for example includes a television (TV), a portable multimedia player (PMP), a tablet computer, a mobile phone, etc.

The image processing apparatus provides various kinds of user input interface such as a remote controller, etc. for allowing a user to make an input. For example, the user input interface may include a voice recognition function. The image processing apparatus supporting the voice recognition function receives a user's speech, converts the speech into a text, and operates corresponding to content of the text. To this end, the image processing apparatus includes a microphone for receiving a user's speech. However, a sound input to the microphone is not limited to only a user's speech. For example, the image processing apparatus materialized as the TV outputs a broadcasting sound through a loudspeaker while displaying a broadcasting image on a display. The microphone basically collects ambient sounds around the image processing apparatus, and therefore collects the broadcasting sound output through the loudspeaker. Accordingly, the image processing apparatus needs to have a structure for extracting components corresponding to a user's speech from the sounds collected in the microphone.

By the way, a conventional image processing apparatus often misrecognizes a user's speech while outputting a broadcasting sound even through there is no user's speech. Such misrecognition is caused by a noise component owing to various factors while the voice recognition function is implemented. Accordingly, there is a need of a structure or method for preventing the image processing apparatus from operating as if a user's speech is recognized even though there is no user's speech.

### SUMMARY

According to an aspect of an exemplary embodiment, there is provided an image processing apparatus including: a loudspeaker configured to output a sound based on a first audio signal; a receiver configured to receive a second audio signal from a microphone; and at least one processor. The processor is configured: to implement a first voice recognition with regard to the first audio signal and the second audio signal, to determine whether a second voice recognition is to be executed according to a result of the first voice recognition, where the second voice recognition is executable for a voice command of a user. The second voice recognition is executed with regard to the second audio signal provided the first audio signal and the second audio signal are different from each other according to the result of the first voice recognition, and the second voice recognition is skipped provided the first audio signal and the second audio signal are equal to each other according to the result of the first voice recognition. Thus, the image processing apparatus is prevented from operating as if a user's speech is recognized even though the user does not makes any speech while the loudspeaker outputs a sound.

The first voice recognition may be executed to convert the second audio signal received by the receiver into a text, and the second voice recognition may be executed to determine the voice command corresponding to the text obtained by the first voice recognition.

The processor may compare a first text obtained by applying the first voice recognition to the first audio signal with a second text obtained by applying the first voice recognition to the second audio signal. Thus, the image processing apparatus easily determine whether there is a user's speech.

The processor may determine the voice command corresponding to the text of the second audio signal provided the second voice recognition is executed with regard to the second audio signal, and may perform an operation instructed by the voice command.

The first audio signal may be extracted from a content signal by demultiplexing the content signal transmitted from a content source to the image processing apparatus. Thus, the image processing apparatus is improved in accuracy of implementing the first voice recognition with regard to the first audio signal.

The sound output through the loudspeaker may be a signal obtained by amplifying the first audio signal, and the first audio signal to be subjected to the first voice recognition of the processor may be an unamplified signal. Thus, the image processing apparatus is improved in accuracy of implementing the first voice recognition with regard to the first audio signal.

The image processing apparatus may further include the microphone.

The receiver may communicate with an external apparatus including the microphone, and the processor may receive the second audio signal from the external apparatus through the receiver. Thus, the image processing apparatus receives a user's speech without including the microphone.

The image processing apparatus may further include a sensor configured to sense motion of a predetermined object, wherein the processor may determine that noise occurs at a point of time when the sensor senses the motion of the object provided a change in magnitude of the second signal is greater than a preset level at the point of time, and may control the noise to be removed. Thus, the image processing apparatus easily determines and removes the noise caused by the motion of the object, thereby improving the results of the first voice recognition.

According to an aspect of another exemplary embodiment, there is provide a non-transitory recording medium recorded with a program code of a method to be executed by at least one processor of an image processing apparatus, the method including: outputting a sound based on a first audio signal through a loudspeaker; receiving a second audio signal from a microphone; executing a first voice recognition with regard to the first audio signal and the second audio signal. The method may include determine whether a second voice recognition is to be executed according to a result of the first voice recognition, the second voice recognition being executable for a voice command of a user, where a second voice recognition is executed with regard to the second audio signal provided the first audio signal and the second audio signal are different from each other according to the result of the first voice recognition, and the second voice recognition is skipped provided the first audio signal and the second audio signal are equal to each other according to the result of the first voice recognition.

The first voice recognition may be executed to convert the second audio signal received in the receiver into a text, and the second voice recognition may be executed to determine the voice command corresponding to the text obtained by the first voice recognition.

The recording medium may further include comparing a first text obtained by applying the first voice recognition to the first audio signal with a second text obtained by applying the first voice recognition to the second audio signal.

The allowing the second voice recognition to be executed may include determining the voice command corresponding to the text of the second audio signal, and performing an operation instructed by the voice command.

The first audio signal may be extracted from a content signal by demultiplexing the content signal transmitted from a content source to the image processing apparatus.

The sound output through the loudspeaker may be a signal obtained by amplifying the first audio signal, and the first audio signal to be subjected to the first voice recognition of the processor may be an unamplified signal.

The image processing apparatus may include the microphone.

The image processing apparatus may communicate with an external apparatus including the microphone, and may receive the second audio signal from the external apparatus.

The recording medium may further include determining that noise occurs at a point of time when a sensor configured to sense motion of a predetermined object senses the motion provided a change in magnitude of the second signal is greater than a preset level at the point of time, and removing the noise.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 illustrates a display apparatus according to an exemplary embodiment;

FIG. 2 is a block diagram of a structure for processing a user's speech in a display apparatus according to the related art;

FIG. 3 is a block diagram of the display apparatus according to an exemplary embodiment;

FIG. 4 is a block diagram of a structure for processing a user's speech in the display apparatus according to an exemplary embodiment;

FIG. 5 is a flowchart of controlling the display apparatus according to an exemplary embodiment;

FIG. 6 is a block diagram of the display apparatus according to an exemplary embodiment and a sound collector;

FIG. 7 is a block diagram of the display apparatus according to an exemplary embodiment and a server; and

FIG. 8 is a block diagram of the display apparatus according to an exemplary embodiment.

### DETAILED DESCRIPTION OF EXEMPLARY EMBODIMENTS

Below, exemplary embodiments will be described in detail with reference to accompanying drawings. The following descriptions of the exemplary embodiments are made by referring to elements shown in the accompanying drawings, in which like numerals refer to like elements having substantively the same functions.

In the description of the exemplary embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the idea of the invention.

Unless otherwise mentioned, embodiments to be respectively described with reference to the accompanying drawings are not exclusive to each other, and a plurality of embodiments may be selectively combined and realized in a single apparatus. Such combination of the plurality of embodiments may be voluntarily selected and applied by a person skilled in the art to materialize the present inventive concept.

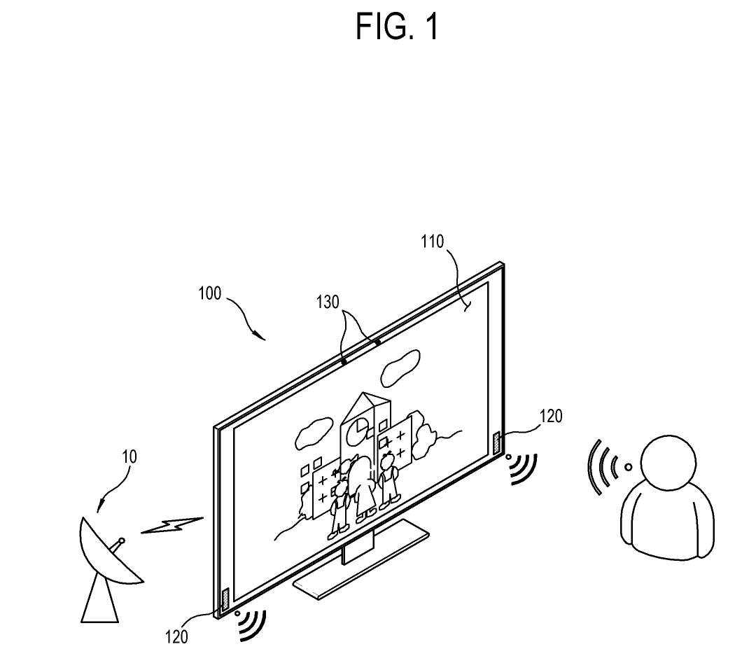

FIG. 1 illustrates a display apparatus according to an exemplary embodiment.

As shown in FIG. 1, a display apparatus 100 according to an exemplary embodiment processes a content signal from a content source 10. The display apparatus 100 displays an image based on a video component of the processed content signal on a display 110, and outputs a sound based on an audio component of the content signal through a loudspeaker 120. In this embodiment, the display apparatus 100 such as a TV is given as an example. Besides the display apparatus 100, the present inventive concept may be applied to an image processing apparatus having no display 110 like a set-top box.

The display apparatus 100 may perform various operations in response to various events, and provide a user input interface for generating such events. There may be various types and kinds of user input interface. For example, the user input interface may include a remote controller provided separately from the display apparatus 100, a menu key provided on an outer side of the display apparatus 100, and a microphone 130 for collecting a user's speech.

The display apparatus 100 according to an exemplary embodiment supports a voice recognition function. The display apparatus 100 recognizes a user's speech collected in the microphone 130, determines a command corresponding to a user's speech, and performs an operation corresponding to the determined command. For example, a user may make a speech of “to a second channel” while the display apparatus 100 reproduces a predetermined broadcasting program of a first channel. Such a user's speech is collected in the microphone 130, and the display apparatus 100 converts the collected speech into text data of “to a second channel”. The display apparatus 100 determines the command corresponding to content of the converted text data, and switches the broadcasting program over to the second channel in response to the corresponding command.

By the way, sounds collectable by the display apparatus 100 through the microphone 130 are not limited to only a user's speech, and fundamentally include all ambient sounds around the display apparatus 100. For example, if a user makes a speech while a sound is output from the loudspeaker 120 of the display apparatus 100, the sounds collected in the microphone 130 includes the sound output from the loudspeaker 120 and the user's speech. The display apparatus 100 extracts only the user's speech from the sounds collected in the microphone 130, excluding the sound output from the loudspeaker 120.

Below, a structure of processing a user's speech will be described according to the related art.

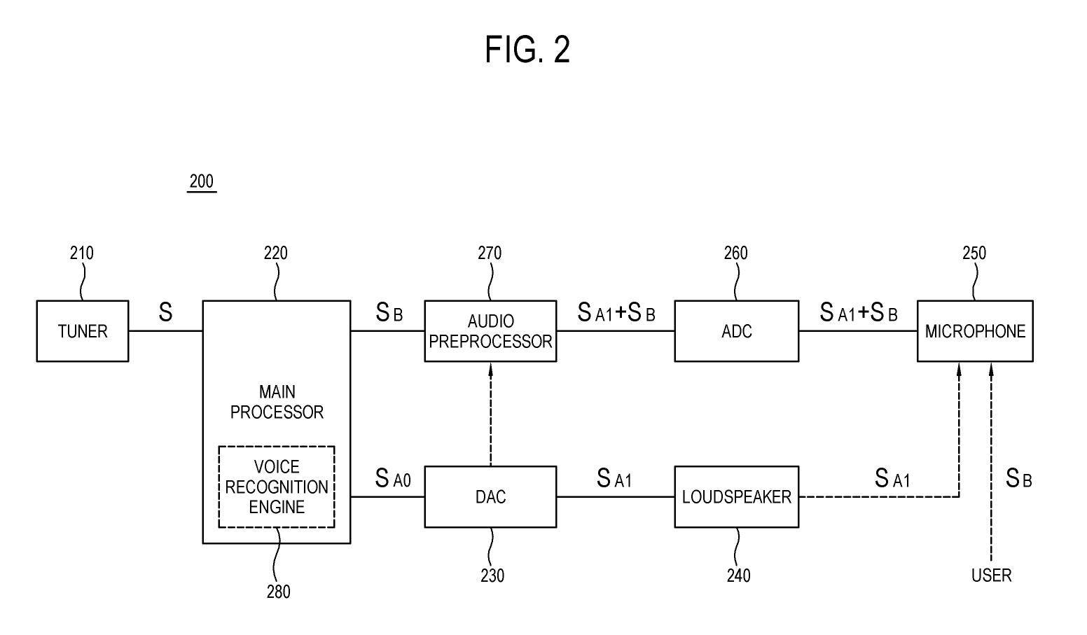

FIG. 2 is a block diagram of a structure for processing a user's speech in a display apparatus according to the related art.

As shown in FIG. 2, a display apparatus 200 according to the related art includes a tuner 210 for receiving a broadcasting signal, a main processor 220 for processing the received broadcasting signal, a digital-analog converter (DAC) 230 for converting a digital signal into an analog signal, a loudspeaker 240 for outputting a sound, a microphone 250 for collecting ambient sounds around the display apparatus 200, an analog-digital converter (ADC) 260 for converting the analog signal into the digital signal, and an audio preprocessor 270 for comparing an input signal with a predetermined reference signal. Of course, the display apparatus 200 includes additional elements such as a display and the like when it is materialized as manufactured goods, but only elements directly related to audio processing will be described in this description.

A broadcasting signal received in the display apparatus 200 is tuned by the tuner 210, and the tuned broadcasting signal is output to the main processor 220. The main processor 220 is achieved by a system on chip (SOC), and includes a voice recognition engine 280 for performing the voice recognition function. The voice recognition engine 280 may be a chipset embedded in the SOC.

A demultiplexing operation for extracting a video signal and an audio signal from the broadcasting signal output from the tuner 210 may be implemented by the main processor 220, or a demultiplexer (DEMUX) added in between the tuner 210 and the main processor 220.

The main processor 220 outputs the audio signal to the DAC 230. The DAC 230 includes an audio amplifier for amplifying a signal. The DAC 230 converts a digital audio signal into an analog audio signal, amplifies the analog audio signal, reflects a previously selected equalizing effect or the like in the amplified audio signal, and outputs the audio signal to the loudspeaker 240. The loudspeaker 240 outputs a sound based on the audio signal from the DAC 230. Thus, the display apparatus 200 outputs a sound through the loudspeaker 240.

With this structure, the display apparatus 200 performs an operation corresponding to a user's speech as follows. The microphone 250 collects ambient sounds, generates an audio signal, and transmits the audio signal to the ADC 260. The ADC 260 converts the analog audio signal into a digital signal and transmits the digital audio signal to the audio preprocessor 270.

The audio preprocessor 270 determines a signal component corresponding to a user's speech within the audio signal. If there is the signal component corresponding to a user's speech, the audio preprocessor 270 transmits the signal component to the main processor 220. The voice recognition engine 280 of the main processor 220 applies voice recognition to the signal component corresponding to a user's speech received from the audio preprocessor 270, so that operations can be performed corresponding to results of the voice recognition.

Details of operations corresponding to a user's speech will be described below focusing on the signal component.

The main processor 220 receives a broadcasting signal S from the tuner 210, and acquires an audio signal SA0 from the broadcasting signal S, thereby outputting the audio signal SA0. The DAC 230 amplifies the audio signal SA0 or reflects a sound effect in the audio signal SA0 so that the audio signal SA0 can be converted into the audio signal SA1 and output through the loudspeaker 240. That is, the audio signal SA1 is obtained by distorting the audio signal SA0. Under this condition, if a user makes a speech, the microphone 250 collects both the audio signal SA1 output from the loudspeaker 240 and a sound SB caused by a user's speech. Therefore, the signal components SA1+SB are transmitted from the microphone 250 to the ADC 260.

The audio preprocessor 270 receives the audio signal SA1+SB from the ADC 260 and compares the audio signal with the audio signal SA1 received from the DAC 230. The audio signal SA1 received from the DAC 230 is used as a reference signal for comparison. In accordance with results of the comparison, the audio preprocessor 270 excludes a broadcasting component, i.e. the audio signal SA1 from the audio signal SA1+SB and thus determines the signal component SB corresponding to a user's speech. The audio preprocessor 270 transmits the determined signal component SB to the main processor 220. The voice recognition engine 280 applies the voice recognition to the signal component SB, so that the main processor 220 can implement an operation instructed by the signal component SB.

By the way, under the conditions that the voice recognition is performed in the display apparatus 200 according to the related art, malfunctions in the voice recognition may occur as follows.

Suppose that an audio signal SA1 of a broadcasting program reproduced in the display apparatus 200 is output through the loudspeaker 240 and a user does not make any speech. If a noise component is not taken into account or ignorable, only the audio signal SA1 is collected in the microphone 250. That is, the audio signal SA1 is transmitted to the audio preprocessor 270 via the ADC 260. Under an ideal condition, there are no signal components transmitted from the audio preprocessor 270 to the main processor 220, and therefore the voice recognition engine 280 does not perform the voice recognition.

On the other hand, under a realistic condition, there is a noise in the display apparatus 200. Such a noise may be made around the display apparatus 200 and collected in the microphone 250, or may be caused by internal elements of the display apparatus 200. The noise may arise from a variety of causes.

Accordingly, the audio preprocessor 270 receives an audio signal SA1+N including not only the signal component SA1 but also a noise component N. The audio preprocessor 270 compares the audio signal SA1+N with the reference signal SA1, and thus sends the main processor 220 the signal component SA1 except the signal component N.

The voice recognition engine 280 applies the voice recognition to the audio signal received from the audio preprocessor 270. For convenience, a range of a signal level within which the voice recognition engine 280 determines an audio signal to be subjected to the voice recognition and applies the voice recognition to the audio signal will be called a tolerance. The tolerance may be determined based on various quantitative characteristics such as a magnitude, an amplitude, a waveform, etc. of a signal. If an audio signal is beyond the tolerance of the voice recognition engine 280, the voice recognition engine 280 does not apply the voice recognition to the audio signal. On the other hand, if an audio signal is within the tolerance of the voice recognition engine 280, the voice recognition engine 280 applies the voice recognition to the audio signal.

This means that if the noise component N output from the audio preprocessor 270 is within the tolerance of the voice recognition engine 280, the voice recognition engine 280 performs the voice recognition with regard to this insignificant noise component. The voice recognition may be processed in a background of the display apparatus 200 so as not to be recognized by a user. However, the display apparatus 200 mostly displays a UI showing information about the process of the voice recognition. If the display apparatus 200 displays the UI related to the process of the voice recognition even though a user does not make any speech, it will be inconvenient for the user.

Besides, the voice recognition engine 280 typically has a larger range of the tolerance than the audio preprocessor 270. This means that the voice recognition engine 280 is highly likely to apply the voice recognition to a certain audio signal if receiving the audio signal from the audio preprocessor 270.

Accordingly, there may be required a method or structure for preventing the display apparatus 200 according to the related art from the malfunction, i.e. from performing the voice recognition even when there were no user's speech.

To this end, exemplary embodiments will be described below.

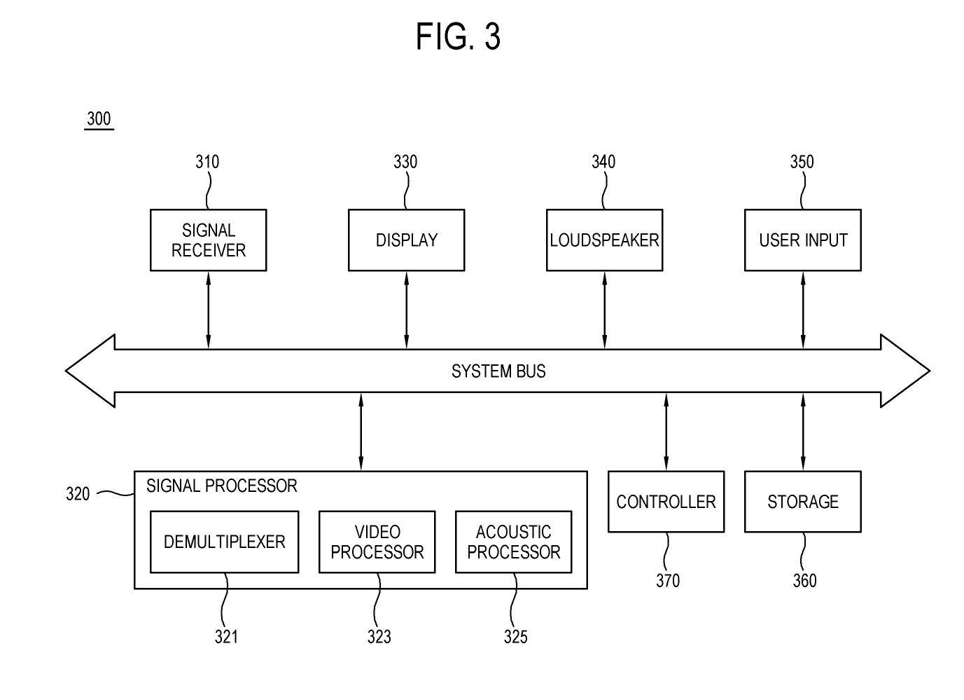

FIG. 3 is a block diagram of the display apparatus according to an exemplary embodiment.

As shown in FIG. 3, the display apparatus 300 according to an exemplary embodiment includes a signal receiver 310 for receiving a content signal from a content source, a signal processor 320 for processing a content signal received through the signal receiver 310, a display 330 for displaying an image based on a video signal of the content signal processed by the signal processor 320, a loudspeaker 340 for outputting a sound based on an audio signal of the content signal processed by the signal processor 320, a user input 350 for receiving a user's input, a storage 360 for storing data, and a controller 370 for performing calculations for the process of the signal processor 320 and control for general operations of the display apparatus 300. These elements are connected to one another through a system bus.

The signal receiver 310 includes a communication chip, a communication module, a communication circuit and the like hardware for receiving a content signal from a content source. The signal receiver 310 is an element for basically receiving a signal or data from the exterior, but not limited thereto. Alternatively, the signal receiver 310 may be used for interactive communication. For example, the signal receiver 310 includes at least one among elements such as a tuner to be tuned to a frequency designated for a broadcast signal; an Ethernet module to receive packet data from the Internet by a wire; a wireless communication module to receive packet data in accordance with wireless communication protocols of Wi-Fi, Bluetooth, etc.; a connection port to which a universal serial bus (USB) memory and the like external device is connected by a wire; and so forth. That is, the signal receiver 310 includes a data input interface circuit where a communication module, a communication port, etc. respectively corresponding to various kinds of communication protocols are combined.

The signal processor 320 performs various processes with respect to a content signal received in the signal receiver 310 so that the content signal can be reproduced. The signal processor 320 includes a hardware processor realized by a chipset mounted to a printed circuit board, a buffer, a circuit and the like, and may be designed as a system on chip (SoC) as necessary. In case where the signal processor 320 is materialized by the SoC, at least two of the signal processor 320, the storage 360 and the controller 370 may be involved in the SoC.

The signal processor 320 includes a demultiplexer 321 for demultiplexing a content signal into a video signal and an audio signal, a video processor 323 for processing the video signal output from the demultiplexer 321 so that the display 330 can display an image based on the processed video signal, and an the acoustic processor 325 for processing the audio signal output from the demultiplexer 321 so that the loudspeaker 340 can output a sound based on the processed audio signal. According to an exemplary embodiment, the demultiplexer 321 is an element provided inside the signal processor 320, but not limited thereto. Alternatively, the demultiplexer 321 may be designed as an element provided outside the signal processor 320.

The demultiplexer 321 demultiplexes the content signal into many signal components by separating packets of the multiplexed content signal in accordance with packet identification (PID). The demultiplexer 321 transmits the demultiplexed signal components to the video processor 323 or the acoustic processor 325 in accordance with respective signal characteristics. However, there are no needs of using the demultiplexer 321 to demultiplex all the content signals. If the video signal and the audio signal are individually input to the display apparatus 300, the process of the demultiplexer 321 may be omitted.

The video processor 323 may be materialized by combination of a plurality of hardware processor chips or by an integrated SoC. The video processor 323 performs decoding, image enhancement, scaling and the like video-related processes with regard to the video signal, and outputs the processed video signal to the display 330.

The acoustic processor 325 may be materialized by a hardware digital signal processor (DSP). In this exemplary embodiment, the acoustic processor 325 is involved in the signal processor 320. Alternatively, the acoustic processor 325 may be provided separately from the signal processor 320. For example, the video processor 323 related to video processes and the controller 370 may be integrated into a single SoC, and the acoustic processor 325 may be materialized as a DSP separated from the SOC. The acoustic processor 325 performs audio channel separation, amplification, volume control, and the like audio-related processes with regard to the audio signal, and outputs the processed audio signal to the loudspeaker 340.

The display 330 displays an image based on the video signal processed by the video processor 323. There are no limits to materialization of the display 330. For example, the display 330 may include a display panel having a light-receiving structure such as a liquid crystal display (LCD) panel or a display panel having a self-emissive structure such as an organic light emitting diode (OLED). Thus, the display 330 may include another element in addition to the display panel in accordance with the structures of the display panel. For example, the display 330 may include an LCD panel, a backlight unit for illuminating the LCD panel, a panel driving substrate for driving the LCD panel, etc.

The loudspeaker 340 outputs a sound based on the audio signal processed by the acoustic processor 325. The loudspeaker 340 may include a unit loudspeaker provided corresponding to audio data of a certain audio channel, and may include a plurality of a plurality of unit loudspeakers respectively corresponding to a plurality of audio channels.

The user input 350 transmits an event caused by a user's input made by various methods to the controller 370. The user input 350 may be variously materialized in accordance with a user's input methods. For example, the user input 350 may include a key provided on an outer side of the display apparatus 300, a touch screen provided on the display 330, a microphone for receiving a user's speech, a camera or sensor for photographing or sensing a user's gesture or the like, a remote controller separated from the display apparatus 300, etc.

The storage 360 stores data in accordance with operations of the signal processor 320 and the controller 370. The storage 360 performs reading, writing, modifying, deleting, updating, etc. with regard to data. The storage 360 includes a nonvolatile memory such as a flash memory, a hard disc drive (HDD), a solid state drive (SSD) and the like to retain data regardless of whether the display apparatus 300 is powered on or off; and a volatile memory such as a buffer, a random access memory (RAM) and the like to which data to be processed by the controller 370 is temporarily loaded.

The controller 370 is materialized by a central processing unit (CPU), a microprocessor, etc. to control operations of elements such as the signal processor 320 in the display apparatus 300, and perform calculations for the processes in the signal processor 320.

Below, the voice recognition structure of the display apparatus 300 will be described in more detail.

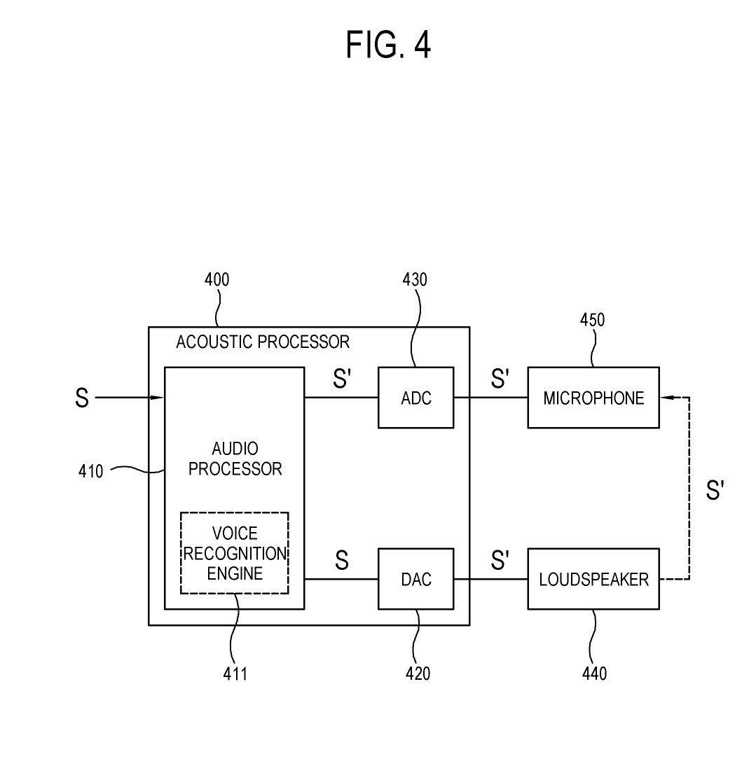

FIG. 4 is a block diagram of a structure for processing a user's speech in the display apparatus according to an exemplary embodiment.

As shown in FIG. 4, an acoustic processor 400 of the display apparatus according to this exemplary embodiment includes an audio processor 410, a DAC 420, and an ADC 430. The audio processor 410 may be integrated into a video processing SOC or may be materialized by an audio DSP separated from the video processing SOC. The audio processor 410 includes a voice recognition engine 411 for performing the processes of the voice recognition. In this exemplary embodiment, the voice recognition engine 411 is involved in the audio processor 410, but not limited thereto. Alternatively, the voice recognition engine 411 may be materialized by a hardware chipset or circuit separated from the audio processor 410.

An audio signal input to the audio processor 410 is extracted from the content signal received in the signal receiver described above with reference to FIG. 3. For example, the audio signal is extracted from the broadcasting signal as the broadcasting signal received in the tuner is demultiplexed by the demultiplexer, and the audio signal is input to the audio processor 410.

The audio processor 410 outputs the audio signal to the DAC 420. The DAC 420 converts a digital audio signal into an analog audio signal, and processes the analog audio signal to be amplified and subjected to sound effects. In this exemplary embodiment, the audio signal is amplified and subjected to the sound effects in the DAC 420, but not limited thereto. Alternatively, an amplifier or the like element may be separately provided for the foregoing operations. A loudspeaker 440 outputs a sound based on the amplified audio signal.

A microphone 450 collects not only the sound output from the loudspeaker 440 but also ambient sounds around the display apparatus. The sounds collected in the microphone 450 are transmitted as the audio signal to the ADC 430, and the ADC 430 converts the analog audio signal into the digital audio signal and transmits the digital audio signal to the audio processor 410.

The voice recognition engine 411 performs the processes of the voice recognition with regard to a predetermined audio signal. With regard to one audio signal, the voice recognition typically includes two processes, i.e. a first process for converting the audio signal into a text by a speech-to-text (STT) process, and a second process for determining a command corresponding to the text obtained as a result of the first process. If the command is determined as a result of the first process and the second process in the voice recognition engine 411, the audio processor 410 performs an operation in response to the determined command.

With this structure, there will be described a method of preventing the display apparatus according to an exemplary embodiment from operating as if a user's speech is recognized in the voice recognition engine 411 even though a user does not makes a speech while the loudspeaker 440 outputs a sound.

An audio signal component S input to the audio processor 410 is processed by the DAC 420 and thus converted into a signal component S′. The signal component S′ is output through the loudspeaker 440, and collected in the microphone 450. The signal component S′ is input from the microphone 450 to the audio processor 410 via the ADC 430. In this state, two kinds of signal component may be input to the audio processor 410, where one is the signal component S extracted from the content signal without amplification and distortion, and the other is the signal component S′ output through the loudspeaker 440 as it is amplified and distorted and then collected in the microphone 450.

The voice recognition engine 411 applies the voice recognition to the signal component S and applies the first process of the voice recognition to the signal component S′. That is, the voice recognition engine 411 performs the first process with regard to each of the signal component S and the signal component S′, and thus obtains texts corresponding to content of the signal component S and content of the signal component S′.

The voice recognition engine 411 determines whether the text of the signal component S is the same as the text of the signal component S′. Since the signal component S′ is obtained by distorting the signal component S through amplification, equalizing effects, etc., there is difference in a signal level between the signal component S and the signal component S′. However, according to an exemplary embodiment, the signal component S and the signal component S′ are compared with respect to not the signal level, but the texts converted from the content of each signal component by the voice recognition engine 411.

If the text of the signal component S is the same as the text of the signal component S′, the voice recognition engine 411 does not perform the second process of the voice recognition. In result, the audio processor 410 is standing by without operating corresponding to the text of the signal component S′. This means that a user does not make any speech since the sound output from the loudspeaker 440 is substantially the same as the sound collected in the microphone 450.

On the other hand, if the text of the signal component S is different from the text of the signal component S′, the voice recognition engine 411 performs the second process of the voice recognition to extract a command issued by a user's speech from the signal component S′, thereby operating the audio processor 410 corresponding to the extracted command. If the text of the signal component S is different from the text of the signal component S′, it means that the sounds collected in the microphone 450 include the sound output from the loudspeaker 440 and another effective sound. Here, it may be regarded that ‘another effective sound’ may be caused by a user's speech.

If the text of the signal component S is different from the text of the signal component S′, it is determined that the signal component S′ includes the signal component S1 converted by the DAC 420 and output through the loudspeaker 440 and the signal component S2 caused by a user's speech. To apply the voice recognition to only S2 excluding S1 from S′=S1+S2 and obtain the text of S2, various structure and methods may be used including the foregoing related art. As one of the examples, the audio processor 410 may specify the signal component S1 by analyzing a waveform of the audio signal, and obtain only the signal component S2 by removing the signal component S1 and noise from the signal component S′.

Thus, the display apparatus according to an exemplary embodiment is prevented from operating as if a user's speech is recognized in the voice recognition even though a user does not makes a speech.

Further, the display apparatus performs only the first process of the voice recognition to determine whether there is a user's speech, and selectively performs the second process of the voice recognition in accordance with determination results. Therefore, the display apparatus does not wastefully perform the second process, reduces a system load, and prevents malfunction of the voice recognition before substantial implantation.

According to an exemplary embodiment, the voice recognition engine 411 implements the first process with regard to the audio signal component S extracted from the content signal and input to the audio processor 410. Thus, the text obtained by applying the first process to such an audio signal extracted from the content signal before being input to the audio processor 410 is more accurate than the text obtained by applying the first process to the signal converted by the DAC 420.

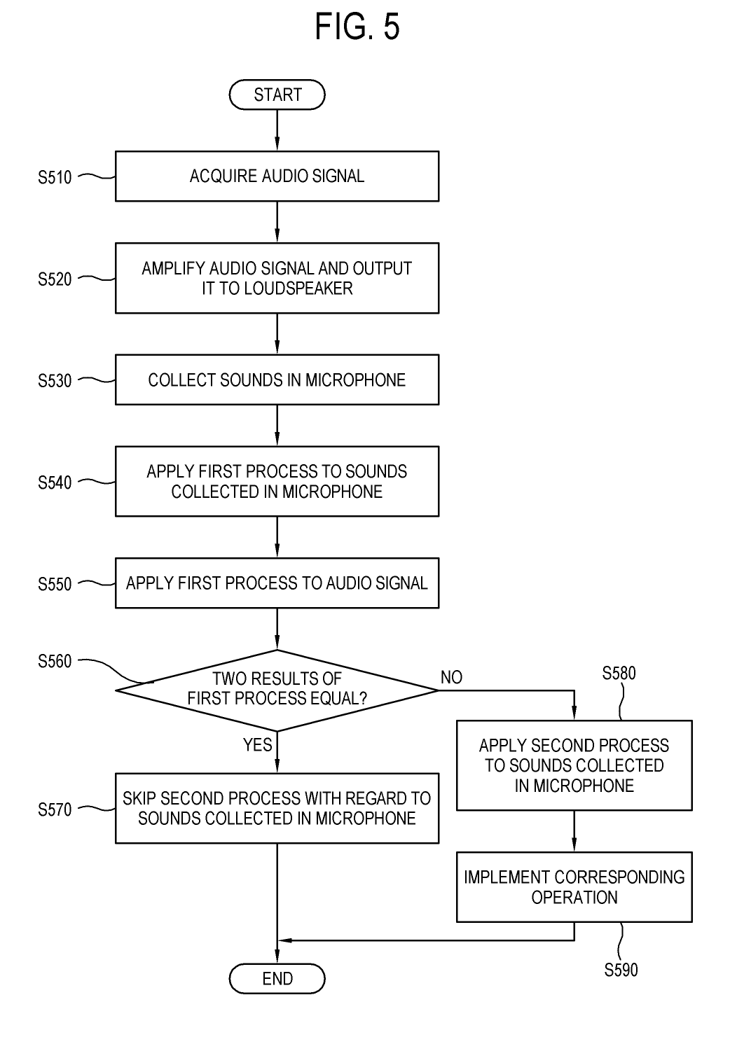

FIG. 5 is a flowchart of controlling the display apparatus according to an exemplary embodiment.

As shown in FIG. 5, at operation S510 the display apparatus acquires an audio signal. The audio signal may be extracted from a content signal by demultiplexing the content signal received from a content source, or may be received from the content source independently of a video signal.

At operation S520 the display apparatus amplifies the audio signal and outputs the amplified audio signal to the loudspeaker.

At operation S530 the display apparatus collects sounds through a microphone.

At operation S540 the display apparatus applies the first process of the voice recognition to the sounds collected in the microphone.

At operation S550 the display apparatus applies the first process of the voice recognition to the audio signal. The audio signal is the signal input in the operation S510.

At operation S560 the display apparatus determines whether the results from applying the first process to the sounds and the audio signal are the same, i.e. whether the result of the first process in the operation S540 is equal to the result of the first process in the operation S550.

If the two results of the first process are the same, it means that the sounds collected in the microphone do not include a user's speech. In this case, at operation S570 the display apparatus does not perform the second process with regard to the sounds collected in the microphone.

On the other hand, if the two results of the first process are different, it means that the sounds collected in the microphone include a user's speech. In this case, at operation S580 the display apparatus determines a user's speech from the sounds collected in the microphone, and determines a command corresponding to the user's speech. At operation S590 the display apparatus operates corresponding to the determined command.

Thus, the display apparatus prevents malfunction of the voice recognition when a user does not make a speech.

In the foregoing exemplary embodiment, the display apparatus includes the microphone, but not limited thereto. Alternatively, the display apparatus may not include the microphone. In this regard, an exemplary embodiment will be described below.

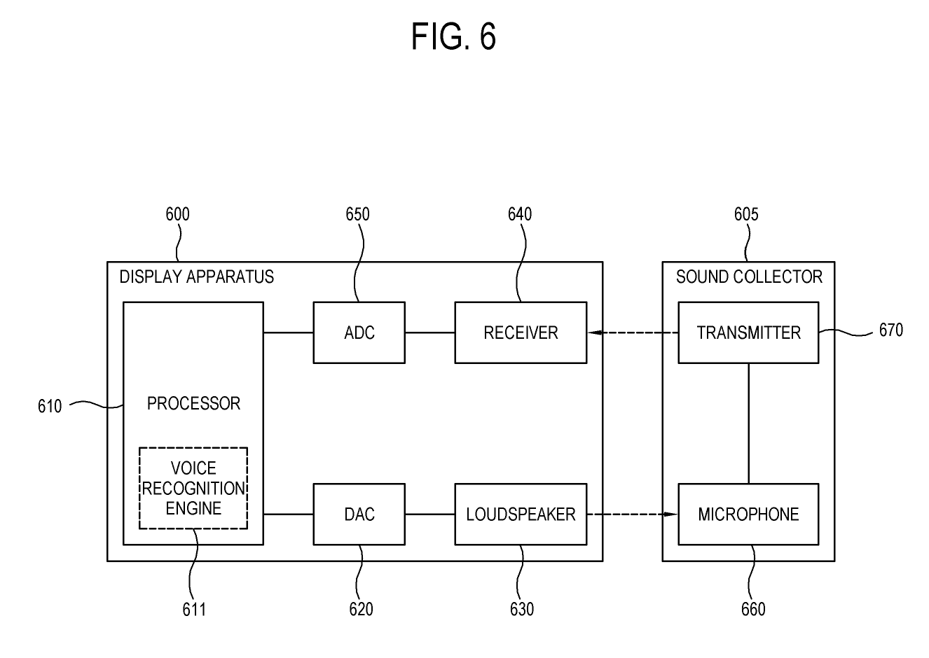

FIG. 6 is a block diagram of the display apparatus according to an exemplary embodiment and a sound collector;

As shown in FIG. 6, a display apparatus 600 according to this exemplary embodiment is capable of communicating with a sound collector 605. The display apparatus 600 and the sound collector 605 are individual apparatuses separated from each other.

The display apparatus 600 includes a processor 610, a DAC 620, a loudspeaker 630, a receiver 640 and an ADC 650. The processor 610 includes a voice recognition engine 611. Operations of the elements except the receiver 640 are equivalent to those of like elements in the foregoing exemplary embodiments. Of course, the display apparatus 600 may further include elements in addition to the foregoing elements. The sound collector 605 includes a microphone 660 and a transmitter 670.

If the processor 610 transmits a first audio signal to the DAC 620, the DAC 620 converts the first audio signal and transmits the converted first audio signal to the loudspeaker 630. The loudspeaker 630 outputs a sound based on the first audio signal converted into the analog signal and subjected to amplification.

The microphone 660 collects sounds output from the loudspeaker 630. The sounds collected in the microphone 660 are converted into a second audio signal and then transmitted to the transmitter 670. The transmitter 670 transmits the second audio signal to the receiver 640. Here, the transmitter 670 and the receiver 640 may be connected to each other by a wire or wirelessly.

The receiver 640 transmits the second audio signal to the ADC 650. The second audio signal is converted by the ADC 650 into a digital signal and then transmitted to the processor 610.

Operations of the processor 610 corresponding to the operations and processing results of the voice recognition engine 611 for implementing the voice recognition with regard to the first audio signal and the second audio signal are equivalent to those of the foregoing embodiments, and therefore repetitive descriptions thereof will be avoided.

According to this exemplary embodiment, the microphone 660 is removed from the display apparatus 600 and added to the separately provided sound collector 605. To accurately collect a user's speech, the microphone 660 has to be arranged as close to the user as possible. However, the microphone 660 is distant from a user in a structure where the microphone 660 is provided in the display apparatus 600. According to this exemplary embodiment, the microphone 660 is separated from the display apparatus 600 and materialized as an independent device, so that the microphone 660 can be close to a user regardless of the position of the display apparatus 600. Further, it is possible to remove the microphone 660 from the display apparatus 600, and it is thus advantageous in light of productivity of the display apparatus 600.

In this exemplary embodiment, the ADC 650 is positioned on a signal path between the receiver 640 and the processor 610, but not limited thereto. Alternatively, the presence and position of the ADC 650 may be varied depending on the respective designs of the display apparatus 600 and the sound collector 605, communication protocols between the transmitter 670 and the receiver 640, etc. For example, the ADC 650 may be positioned on a signal path between the transmitter 670 and the microphone 660 of the sound collector 605.

In the foregoing exemplary embodiments, the voice recognition engine is internally provided in the processor. However, the voice recognition engine may be separated from the processor within the display apparatus. In this case, the voice recognition engine may communicate with the processor, thereby receiving an audio signal for voice recognition from the processor, and transmitting a text based on results of the voice recognition to the processor.

Further, the voice recognition engine may be installed in not the display apparatus but a server communicating with the display apparatus, and this will be described below.

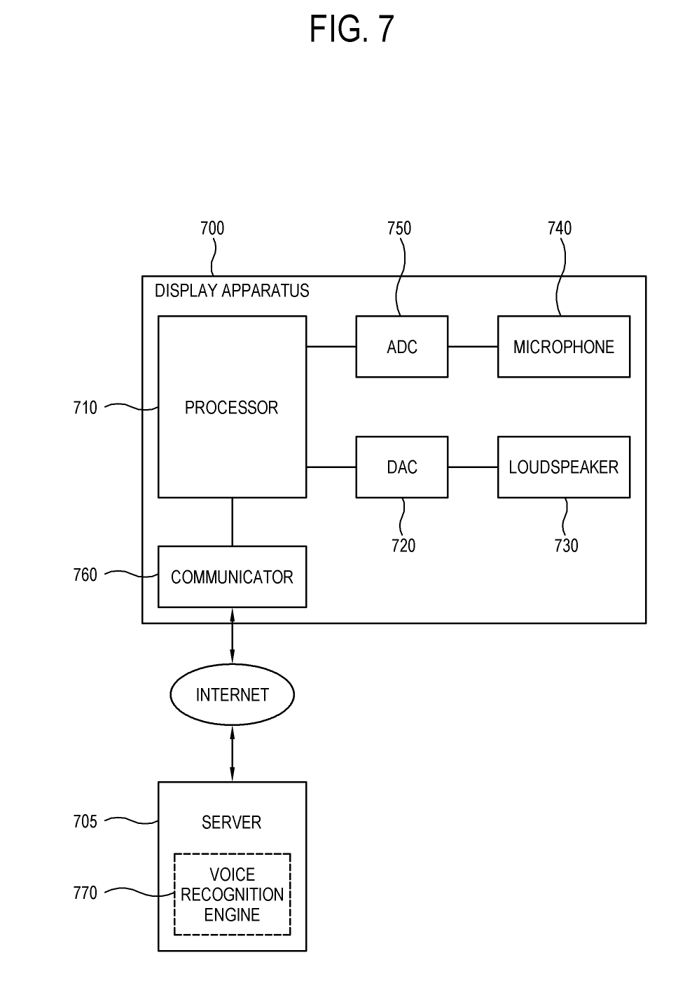

FIG. 7 is a block diagram of the display apparatus according to an exemplary embodiment and a server.

As shown in FIG. 7, a display apparatus 700 in this embodiment communicates with a server 705 through the Internet. The display apparatus 700 includes a processor 710, a DAC 720, a loudspeaker 730, a microphone 740, an ADC 750 and a communicator 760. The server 705 interactively communicates with the communicator 760 of the display apparatus 700, and includes a voice recognition engine 770 for performing voice recognition.

If the processor 710 transmits a first audio signal to the DAC 720, the first audio signal is converted by the DAC 720 and then transmitted to the loudspeaker 730. The loudspeaker 730 outputs a sound based on the first audio signal converted into an analog signal and subjected to amplification.

The microphone 740 collects sounds output from the loudspeaker 730. The sounds collected in the microphone 740 are converted into a second audio signal and transmitted to the ADC 750. The second audio signal is converted into a digital signal by the ADC 750 and then transmitted to the processor 710.

The processor 710 transmits the first audio signal and the second audio signal to the server 705 through the communicator 760. The server 705 applies the voice recognition of the voice recognition engine 770 to each of the first audio signal and the second audio signal received from the display apparatus 700, and transmits the recognition results to the display apparatus 700.

The processor 710 compares the first audio signal and the second audio signal received from the server 705 with respect to a text. Operations according to the comparison results are equivalent to those of the foregoing exemplary embodiment, and thus repetitive descriptions will be avoided.

By the way, there may be many cases about when the display apparatus according to an exemplary embodiment will implement the foregoing operations. For example, the display apparatus may implement the foregoing operations every preset cycle while reproducing predetermined content. Alternatively, the display apparatus may implement the foregoing operations only when it is determined that there is a user around the display apparatus.

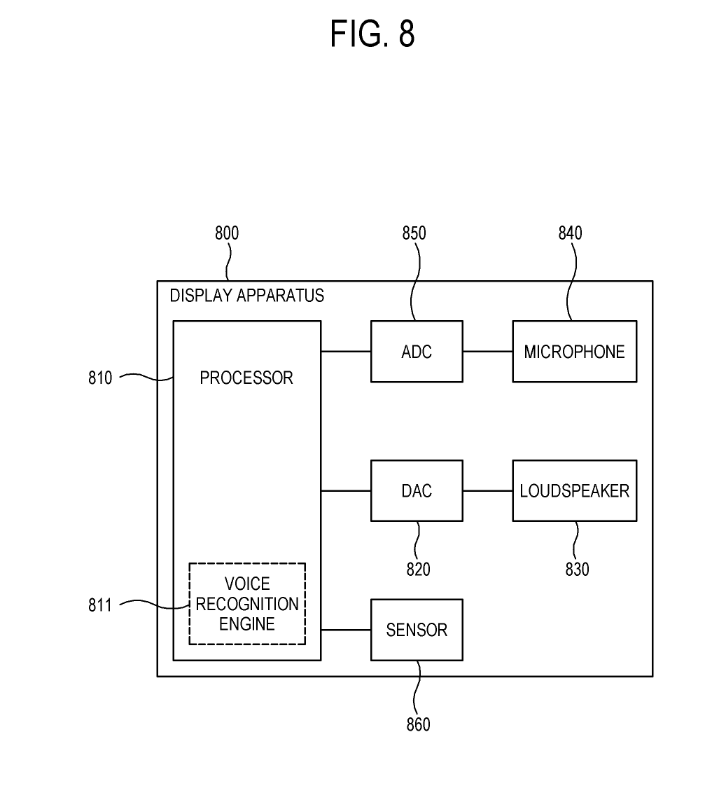

FIG. 8 is a block diagram of the display apparatus according to an exemplary embodiment.

As shown in FIG. 8, a display apparatus 800 includes a processor 810, a DAC 820, a loudspeaker 830, a microphone 840, an ADC 850, and a sensor 860, and the processor 810 includes a voice recognition engine 811. The elements except the sensor 860 are equivalent to those of the foregoing exemplary embodiment, and thus repetitive descriptions will be avoided.

The sensor 860 is provided to sense presence or motion of a certain object around the display apparatus 800, and may be variously materialized by a camera, a photo-sensor, an ultrasonic sensor, etc. The sensor 860 senses whether there is a user around the display apparatus 800.

If the sensor 860 senses a user, the display apparatus 800 has to implement the voice recognition. On the other hand, if the sensor 860 senses no user, the display apparatus 800 does not have to implement the voice recognition. If there are no needs of implementing the voice recognition, the elements related to the voice recognition, i.e. the voice recognition engine 811, the ADC 850, the microphone 840 and the like do not have to operate.

Therefore, the display apparatus 800 uses the sensor 860 to perform monitoring while the loudspeaker 830 outputs a sound. If the sensor 860 senses a user, the display apparatus 800 collects sounds through the microphone 840 and implements the processes for determining whether a user's speech is included in the collected sounds as described above in the foregoing exemplary embodiments.

On the other hand, if the sensor 860 senses no user, the display apparatus 800 does not implement the foregoing processes. For example, the display apparatus 800 inactivates the voice recognition engine 811, or additional inactivates the ADC 850 or the microphone 840 related to the voice recognition. Alternatively, the display apparatus 800 may control the voice recognition engine 811 not to implement the voice recognition, without inactivating the voice recognition engine 811.

Thus, the display apparatus 800 may use the sensor 860 to selectively implement the processes.

The sensor 860 may be variously used. For example, the sensing results of the sensor 860 may be used to remove noise from the sounds collected in the microphone 840.

A waveform of an audio signal of the sounds collected in the microphone 840 is varied in magnitude as time goes on. If where noise included in the sounds collected by the microphone 840 is caused by motion of an object around the display apparatus 800, that is, if the magnitude or amplitude of the audio signal is rapidly changed at a point of time when the movement of the object is sensed, the display apparatus 800 may determine that the noise occurs.

In other words, when the sensor 860 senses motion of a predetermined object, the display apparatus 800 determines whether change in magnitude or amplitude of the audio signal is greater than a preset level at a point of time when the motion is sensed. If the change in magnitude or amplitude of the audio signal is not greater than the preset level, the display apparatus 800 determines that no noise occurs at the point of time.

On the other hand, if the change in magnitude or amplitude of the audio signal is greater than the preset level, the display apparatus 800 determines that noise occurs at the point of time and performs a process to remove the noise. There are many ways for removing the noise, and thus there are no limits to the process mentioned in this embodiment. For example, the display apparatus 800 may adjust a magnitude level at a first point of time when noise occurs to be within a preset range from a magnitude level at a second point of time adjacent to the first point of time.

The methods according to the foregoing exemplary embodiments may be achieved in the form of a program command that can be implemented in various computers, and recorded in a computer readable medium. Such a computer readable medium may include a program command, a data file, a data structure or the like, or combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for realizing the exemplary embodiments. The program command recorded in this storage medium may be specially designed and configured according to the exemplary embodiments, or may be publicly known and available to those skilled in the art of computer software.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An image processing apparatus comprising:
a loudspeaker configured to output a sound based on a first audio signal;
a receiver configured to receive a second audio signal from a microphone; and
at least one processor configured:
to execute a first voice recognition with regard to the first audio signal and the second audio signal respectively,
to execute a second voice recognition with regard to the second audio signal in response to results from applying the first voice recognition to the first audio signal and the second audio signal being different from each other, and
to skip the second voice recognition with regard to the second audio signal in response to the results from applying the first voice recognition to the first audio signal and the second audio signal being equal to each other.

2. The image processing apparatus according to claim 1, wherein the first voice recognition is executed to convert the second audio signal received by the receiver into a text, and
the second voice recognition is executed to determine the voice command corresponding to the text obtained by the first voice recognition.

3. The image processing apparatus according to claim 1, wherein the least one processor compares a first text obtained by applying the first voice recognition to the first audio signal with a second text obtained by applying the first voice recognition to the second audio signal.

4. The image processing apparatus according to claim 1, wherein the least one processor determines the voice command corresponding to a text of the second audio signal provided the determining determines the second voice recognition is to be executed to the second audio signal, and performs an operation instructed by the voice command.

5. The image processing apparatus according to claim 1, wherein the first audio signal is extracted from a content signal by demultiplexing the content signal transmitted from a content source to the image processing apparatus.

6. The image processing apparatus according to claim 1, wherein the sound output through the loudspeaker is a signal obtained by amplifying the first audio signal, and
the first audio signal to be subjected to the first voice recognition of the least one processor is an unamplified signal.

7. The image processing apparatus according to claim 1, wherein the microphone is comprised in the image processing apparatus.

8. The image processing apparatus according to claim 1, wherein the receiver communicates with an external apparatus comprising the microphone, and
the least one processor receives the second audio signal from the external apparatus through the receiver.

9. The image processing apparatus according to claim 1, further comprising:
a sensor configured to sense motion of a predetermined object,
wherein the least one processor determines that noise occurs at a point of time when the sensor senses the motion of the object provided a change in magnitude of the second signal is greater than a preset level at the point of time, and controls the noise to be removed.

10. A non-transitory recording medium recorded with a program code of a method executable by at least one processor of an image processing apparatus, the method comprising:
outputting a sound based on a first audio signal through a loudspeaker;
receiving a second audio signal from a microphone;
executing a first voice recognition with regard to the first audio signal and the second audio signal respectively;
executing a second voice recognition with regard to the second audio signal in response to results from applying the first voice recognition to the first audio signal and the second audio signal being different from each other; and
skipping the second voice recognition with regard to the second audio signal in response to the results from applying the first voice recognition to the first audio signal and the second audio signal being equal to each other.

11. The recording medium according to claim 10, wherein the first voice recognition is executed to convert the second audio signal received by the receiver into a text, and the second voice recognition is executed to determine the voice command corresponding to the text obtained by the first voice recognition.

12. The recording medium according to claim 10, further comprising:
comparing a first text obtained by applying the first voice recognition to the first audio signal with a second text obtained by applying the first voice recognition to the second audio signal.

13. The recording medium according to claim 10, wherein the execution of the second voice recognition comprises determining the voice command corresponding to the text of the second audio signal, and performing an operation instructed by the voice command.

14. The recording medium according to claim 10, wherein the first audio signal is extracted from a content signal by demultiplexing the content signal transmitted from a content source to the image processing apparatus.

15. The recording medium according to claim 10, wherein the sound output through the loudspeaker is a signal obtained by amplifying the first audio signal, and
the first audio signal to be subjected to the first voice recognition of the processor is an unamplified signal.

16. The recording medium according to claim 10, wherein the microphone is comprised in the image processing apparatus.

17. The recording medium according to claim 10, wherein the image processing apparatus communicates with an external apparatus comprising the microphone, and receives the second audio signal from the external apparatus.

18. The recording medium according to claim 10, further comprising:
determining that noise occurs at a point of time when a sensor configured to sense motion of a predetermined object senses the motion provided a change in magnitude of the second signal is greater than a preset level at the point of time, and removing the noise.
